(19) United States
(12) Patent Application Publication
(10) Pub. No.: US 2005/0023206 A1
(43) Pub. Date: Feb. 3, 2005

(54) Water filter adapter with locking feature

(76) Inventor: Karl Fritze, Denmark Township, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/902,695

(22) Filed: Jul. 29, 2004

Related U.S. Application Data
(60) Provisional application No. 60/490,852, filed on Jul. 29, 2003.

(51) Int. Cl. B01D 35/30

(52) U.S. Cl. 210/235

(57) ABSTRACT

Improved water filtration assemblies comprise a distribution manifold, a filter adapter and a filter cartridge, wherein the filter adapter connects the distribution manifold to the filter cartridge such that one or more fluid flow pathways from the distribution manifold to the filter cartridge are established. Additionally, the filter adapters of the present disclosure can comprise a lock, which can lock or secure the filter adapter to the distribution manifold such that a user can engage and disengage a filter cartridge from the adapter without the filter adapter disengaging from the distribution manifold. Due to the presence of the filter adapter, and the lock that secures the filter adapter to the distribution manifold, a consumer can easily engage and disengage replacement filter cartridges from the filter adapter without disengaging the adapter from the manifold. In some embodiments, the adapter has an improved design configuration.

### CROSS-REFERENCE TO RELATED APPLICATIONS

The current application claims the benefit of priority from U.S. provisional patent application filed on Jul. 29, 2003, entitled “Water Filter Adapter With Locking Feature” having Ser. No. 60/490,852, which is incorporated herein by reference.

### FIELD OF THE INVENTION

The present invention relates generally to the field of residential water filtration systems. More specifically, the present invention relates, in some embodiments, to an adapter that can have a locking feature such that the adapter can be fixedly mounted to a manifold, the adapter allowing for use of alternative cartridge filter designs.

### BACKGROUND OF THE INVENTION

Water filtration systems designed for use in the home, such as refrigerator and under-sink systems, are known. Due to increasing quality and health concerns with regard to municipal and well-water supplies, the popularity of such systems has increased markedly in recent years. For example, the inclusion of water filtration systems in refrigerators, once considered a luxury feature, is now included as a standard feature in all but entry level refrigerator designs.

A typical residential water filtration system generally includes a distribution manifold configured to accept a prepackaged cartridge filter. The distribution manifold is typically adapted to connect either directly or indirectly to the residential water supply and to points of use and may even allow for a drain connection. Generally, the prepackaged cartridge filter sealingly engages the distribution manifold such that an inlet flow channel connecting the residential water supply and the cartridge filter is defined and at least one outlet flow channel connecting the cartridge filter and the points of use and/or the drain is defined.

Generally, the distribution manifold and cartridge filter are sealingly engaged using a variety of specific engagement mechanisms such that the filter specifically mates with the manifold, resulting in a ready-to-use water filtration system. The distribution manifold can be incorporated for long-term use into an appliance such as a refrigerator or a filter unit connected to a water supply. Thus, the filter is generally replaced when spent, while the manifold and other portions of the appliance remain. The use of a specific engagement mechanism between the filter and manifold can be advantageous to the manufacturer since the consumer is limited to purchasing replacement filter cartridges with the appropriate engagement mechanisms. With a captured market such as described, the manufacturer may have little incentive to add desirable features, such as newly available filtration media, leak resistance or monitoring features, to these replacement filters.

### SUMMARY OF THE INVENTION

The cartridge filter adapter of the present invention provides multiple replacement options when replacing spent cartridge filters. Using the cartridge filter adapter in some embodiment, the consumer can effect an enduring change in the filter cartridge engagement structure, especially with an engagement structure that has keying features, such that prepackaged cartridge filters with a different attachment configuration can be sealingly installed as part of the water filtration system. The replacement filters with different attachment configurations may be supplied by an alternative manufacturer. Following installation of the cartridge filter adapter, replacement and usage of these alternative cartridge filters becomes transparent to the consumer. In particular, if locked, the adapter remains attached to the manifold so that the filters can be replaced without considering the presence of the adapter, which effectively alters the manifold to have a different filter attachment connection. In some embodiments, improved adapter configurations can be used to adapt a filter to a manifold.

For initial installation of the adapter, an installation tool can be used that provides for easy handling and reaching with the adapter for mounting the adapter to the manifold. Alternatively, a replacement filter attached to an adapter can facilitate gripping and placement of the adapter onto the manifold.

In one aspect, the invention pertains to a filter adapter comprising a manifold coupler, a filter coupler, a lock, a supply channel fluidly connecting the manifold coupler and the filter coupler, and a filter outlet channel fluidly connecting the manifold coupler and the filter coupler. In these embodiments, the filter outlet channel can be isolated from the supply inlet channel and wherein the manifold coupler is adapted to engage a manifold and the filter coupler is adapted for engaging a filter cartridge, the lock structure being positioned on the adapter to engage the manifold when the manifold coupler is engaged with the manifold. The lock resists the disengagement of the filter from the manifold.

In a second aspect, the invention pertains to a method of adapting a filter manifold comprising a filter-to-manifold coupler, the method comprising attaching a locking adapter to the filter-to-manifold coupler wherein the locking adapter comprises a filter-to-adapter coupler having a different configuration than the filter-to-manifold coupler and wherein the locking adapter comprises a lock that resists removal of the adapter from the manifold.

In another aspect, the invention pertains to a filtration assembly comprising a manifold having a lock engaging member, an inlet connection, an outlet connection and a filter-to-manifold coupler. In these embodiments, the filtration assembly can further comprise a filter comprising a case, a filter medium sealed within the case and a manifold-to-filter coupler having an inlet port and an outlet port, and an adapter having a lock element, a manifold-to-adapter coupler mated to the filter-to-manifold coupler of the manifold, a filter-to-adapter coupler mated to the manifold-to-filter coupler of the filter to provide separate isolated passages with one between the manifold and the filter inlet port and a second between the manifold and the filter outlet port. The lock element engages the lock-engaging member.

In a further aspect, the invention pertains to a filter adapter comprising a manifold coupler, a filter coupler, a first channel fluidly connecting the manifold coupler and the filter coupler, and a second channel fluidly connecting the manifold coupler and the filter coupler. The first channel is isolated from the second channel. The manifold coupler is adapted to engage a manifold, and the filter coupler is adapted for engaging a filter cartridge. In some embodiments, the first channel comprises a central channel extending through the manifold coupler and the filter coupler, and the second channel is positioned radially outward from the central channel.

### BRIEF DESCRIPTION OF THE FIGURES

FIG. 1 is an exploded, perspective view of an embodiment of a cartridge filter adapter of the present invention.

FIG. 2 is a side view of the cartridge filter adapter of FIG. 1.

FIG. 3 is a perspective, end view of the cartridge filter adapter of FIG. 1.

FIG. 4 is an end view of the cartridge filter adapter of FIG. 1.

FIG. 5 is a sectional view of the cartridge filter adapter of FIG. 1, taken along section B-B as shown in FIG. 4.

FIG. 6 is a fragmentary side view of a water filtration system using the cartridge filter adapter of the present invention.

FIG. 7 is a fragmentary side view of a locking tab engaging a corresponding locking projection of a manifold.

FIG. 8a is a side of an alternative embodiment of a manifold that fits over the adapter to engage a locking tab with teeth that inhibit counter rotation of the adapter, in which the features of the manifold are shown in phantom lines.

FIG. 8b is a fragmentary top view of the embodiment in FIG. 8a depicting the engagement of a locking tab with teeth that provide for one direction of rotation.

FIG. 9 is a side view of the cartridge filter adapter attached to a distribution manifold with an insertion tool.

### DETAILED DESCRIPTION OF THE INVENTION

Water filtration assemblies, as described herein, can comprise a distribution manifold, a filter adapter and a filter cartridge with the filter adapter connecting the distribution manifold to the filter cartridge such that one or more fluid flow pathways from the distribution manifold to the filter cartridge are established. Additionally, the filter adapters of the present disclosure can comprise a lock, which can lock or secure the filter adapter to the distribution manifold such that a user can engage and disengage a filter cartridge from the adapter without the filter adapter disengaging from the distribution manifold. Additionally, the filter adapters can provide alternative filter cartridges replacement options. Specifically, an adapter can be selected such that the consumer can correspondingly select a replacement filter cartridge based upon desired features, instead of being limited to replacement filter cartridges that are designed to directly interface with the distribution manifold. In some embodiments, the adapted have desirable flow features.

As described above, appliances, for example, refrigerators, can include a water filtration assembly comprising a distribution manifold designed to couple with a cartridge filter. Generally, the distribution manifold and the cartridge filter can be sealingly engaged by specific engagement mechanisms, such that only specific replacement filters can sealingly interface with distribution manifold. The availability of locking adapters, as described herein, provides the capability to conveniently alter the manifold to provide for the installation of different filters to the manifold. Thus, different filters can be installed without replacing the manifold in the appliance, which can be a significant effort.

One method that has been used to provide consumers with replacement cartridge filter options has been to provide an adapter between the distribution manifold and the cartridge filter as described in U.S. Pat. Nos. 6,360,764 and 6,426,001; both of which are hereby incorporated by reference in their entirety. Generally, these adapters provide consumers with an opportunity to use selected cartridge filters having desired features and filtering characteristics even if these cartridge filters are not individually attachable to the distribution manifold. The present adapters further improve on the adapter features by fixedly engaging, or locking, the adapter with the manifold. Also, in some of the particular embodiments herein, particular manifold coupling configurations for connecting with corresponding manifold designs are shown.

In some embodiments, the residential water filtration system comprises a filter adapter for enduring attachment to a distribution manifold. Once the filter adapter is sealingly engaged with the distribution manifold, a cartridge filter that is adapted to sealingly engage the filter adapter can be installed to complete a water filtration system. Due to the locking feature, the filter adapter generally remains sealingly engaged to the distribution manifold such that routine replacement of spent cartridge filters involves only removal of a spent filter from the filter adapter and attachment of a replacement filter to the filter adapter. However, in other embodiments, the filter adapter may be removable with some specific effort to disengage the lock, to allow replacement with an alternative filter adapter or to allow direct engagement of a cartridge filter with the distribution manifold.

Generally, the filter adapters of the present disclosure comprise a manifold coupler and a filter coupler to provide the corresponding connections. The manifold coupler can comprise a manifold connection structure that facilitates engagement of the manifold coupler to a distribution manifold, while the filter coupler can comprise a filter connection structure that facilitates engagement of a filter cartridge with the filter coupler. As described above, the filter adapter generally comprises structure that defines one or more fluid flow pathways through the filter adapter such that fluids can flow from a distribution manifold through the filter adapter to a filter cartridge. Specifically, the filter adapter can have an unfiltered fluid flow pathway and a filtered fluid flow pathway isolated from the unfiltered fluid pathway such that water from the distribution manifold can travel through the unfiltered flow pathway to the filter cartridge, and from the filter cartridge back to the distribution manifold through the filtered fluid flow pathway.

Additionally, the filter adapter generally can comprise a lock that locks the filter adapter to the distribution manifold. In some embodiments, the lock can comprise a connection element such as a tab, groove or the like located on an outside surface of the filter adapter that is designed to engage with a corresponding connection element located on a distribution manifold to secure the filter adapter to the distribution manifold.

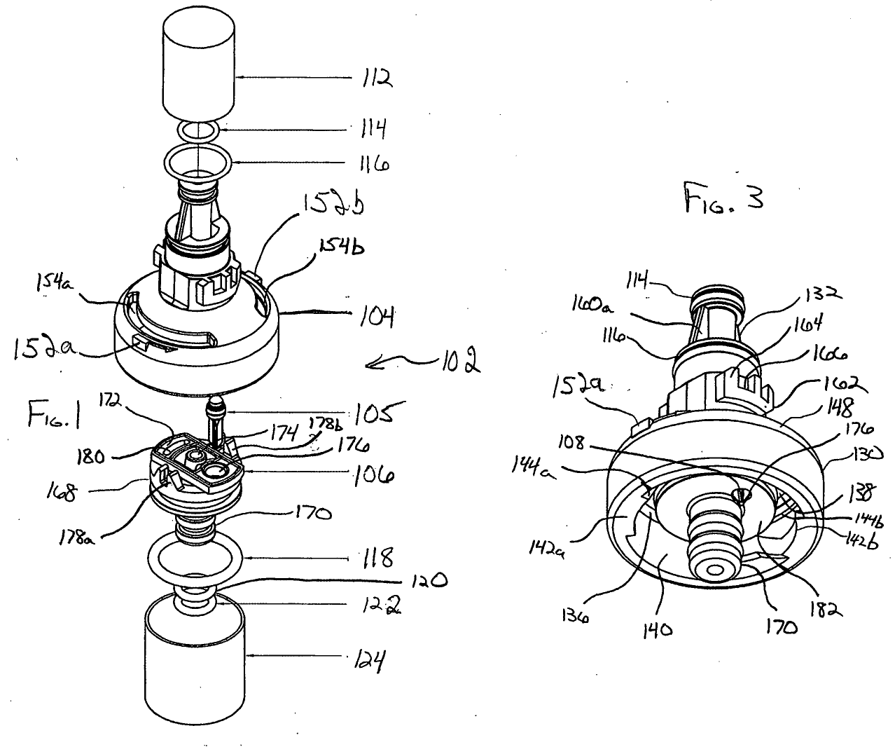

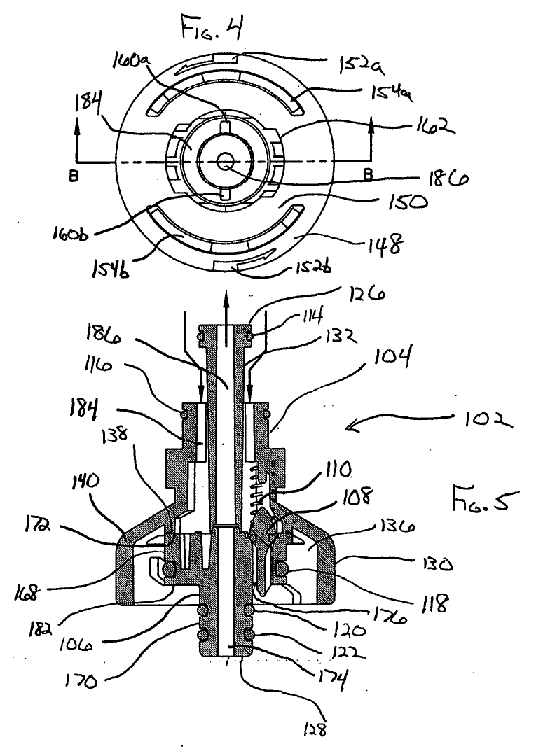

A filter adapter 102 is illustrated in FIGS. 1 and 2. Generally, a manifold coupler 104 and a filter coupler 106 are attached and permanently bonded to form filter adapter 102. Suitable bonding methods could include sonic welding, spin welding, vibrational welding, hot plate welding, RF welding, laser welding or the like. Valve assembly 105 typically comprises a valve member 108 and a valve spring 110 as shown in FIG. 5. In alternative embodiments, the adapter does not include a valve assembly. For purposes of shipping, transporting and installing the filter adapter system 102, filter adapter system 102 further comprises a first shipping cap 112, a first manifold seal 114, a second manifold seal 116, a first filter seal 118, a second filter seal 120, a third filter seal 122 and a second shipping cap 124. Shipping cap 112 and 124 are removed for use. Seals 114, 116, 118, 120 and 122 provide for sealing engagement, respectively with the manifold and filter when in use. As shown, filter adapter 102 is defined by a manifold engagement end 126 and a filter engagement end 128.

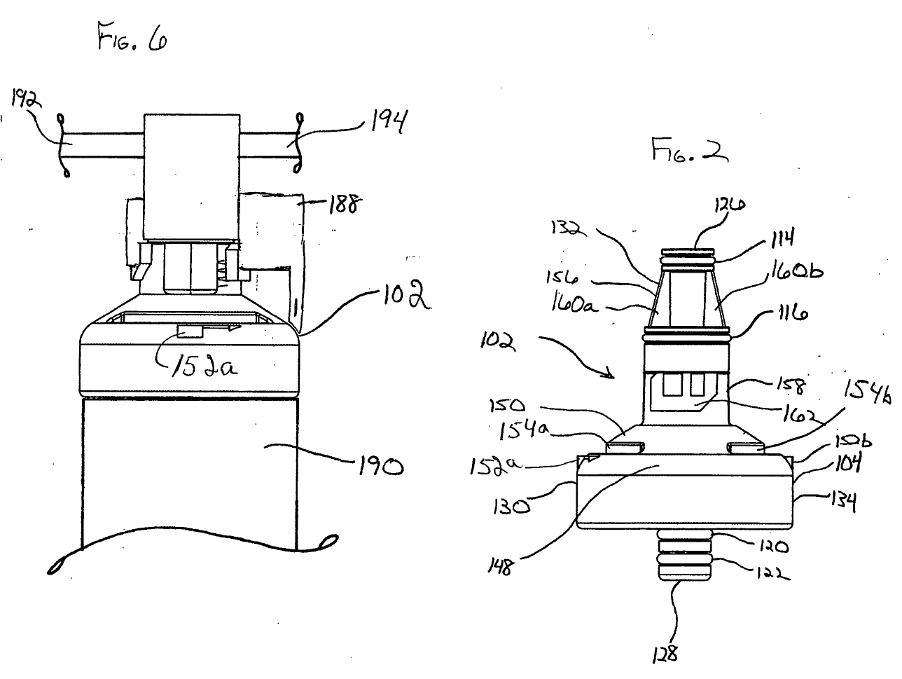

As shown in FIGS. 2 and 3, manifold coupler 104 comprises a body section 130 and a manifold insertion section 132. Body section 130 has a perimeter surface 134. In some embodiments, body section 130 has a diameter such that perimeter surface 134 aligns with a cartridge filter outer surface for aesthetic reasons. Body section 130 includes an interior recess 136 defined by a recess surface 138 and interior recess wall 140. Recess wall 140 comprises a pair of recess tabs 142a, 142b and a pair of perimeter ramps 144a, 144b. Body section 130 also has a rounded edge surface 148, shown in FIG. 4, transitioning into an angled face surface 150. Rounded edge surface 148 has a pair of locking tabs 152a, 152b. Angled face surface 150 includes a pair of arcuate apertures 154a, 154b, as shown in FIG. 1.

Manifold insertion section 132 includes an insertion portion 156 and an engagement portion 158. Insertion portion 156 is adapted to accommodate the first manifold seal 114. Insertion portion also includes a pair of angle insertion supports 160a, 160b. Engagement portion 158 is adapted to accommodate the second manifold seal 116. Engagement portion 158 can comprise at least one key member 162 comprising a series of tabs 164 and recesses 166.

Filter coupler 106 is shown in FIGS. 1 and 3. Filter coupler 106 comprises a body section 168 and a filter insertion section 170. Body section 168 has an attachment face 172 that includes a filtered water bore 174, an unfiltered water bore 176, a pair of attachment members 178a, 178b and an alignment aperture 180. Body section 168 is adapted to accommodate first filter seal 118. Body section 168 also has a sealing surface 182 that comprises one end of the unfiltered water bore 176. Filter insertion section 170 is adapted to accommodate second filter seal 120 and third filter seal 122.

In assembling filter adapter 102, manifold coupler 104 and filter coupler 106 are oriented such that recess surface 138 and attachment face 172 face one another. Valve assembly 105 may be placed within unfiltered water bore 176 on attachment face 172 such that valve spring 110 is oriented toward recess surface 138. Manifold coupler 104 is directed such that attachment face 172 is inserted into interior recess 136. As attachment face 172 approaches recess surface 138, attachment members 178a, 178b engage attachment apertures 146a, 146b. As attachment face 172 sealingly engages recess surface 138, attachment members 178a, 178b interact with attachment apertures 146a, 146 to form filter adapter 102, as shown in FIG. 5.

As illustrated in FIG. 5, filter adapter 102 defines a continuous flow path between the unfiltered water bore 176 of filter coupler 106 and a circumferential unfiltered water bore 184 within manifold coupler 104, as well a flow path between filtered water bore 174 of filter coupler 106 and filtered water bore 186 within manifold coupler 104.

In general, the nature of the continuous flow path of unfiltered water, filtered water and an optional drain are selected appropriately for the manifold and corresponding filter. Drains, for example, can be used for reverse osmosis filters such as described in U.S. Provisional Patent Application Ser. No. 60/467,663 entitled, “Residential Reverse Osmosis System With Quick Dry Change Elements,” which is hereby incorporated by reference in its entirety. In some embodiments, filter adapter system may comprise flow paths suitable for converting a standard filtration system having an unfiltered water inlet and a filtered water outlet to a reverse osmosis filtration system including an unfiltered water inlet, a filtered water outlet and a drain outlet.

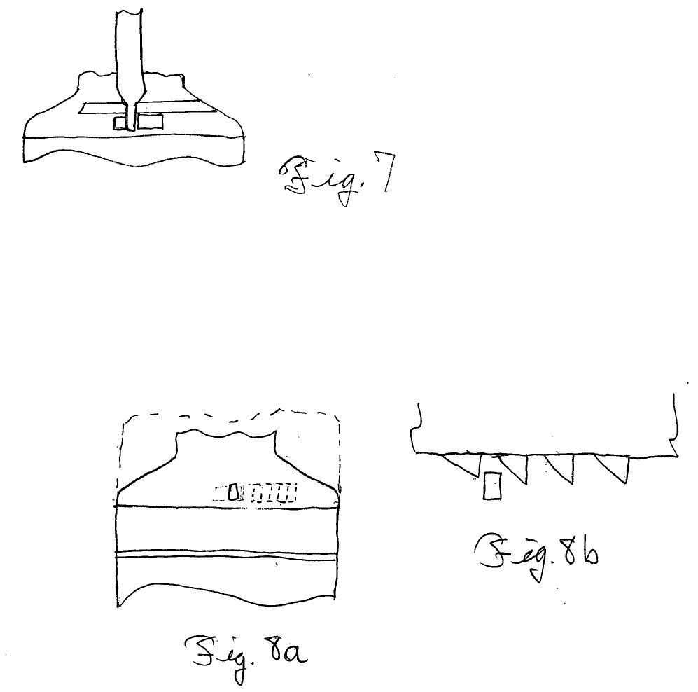

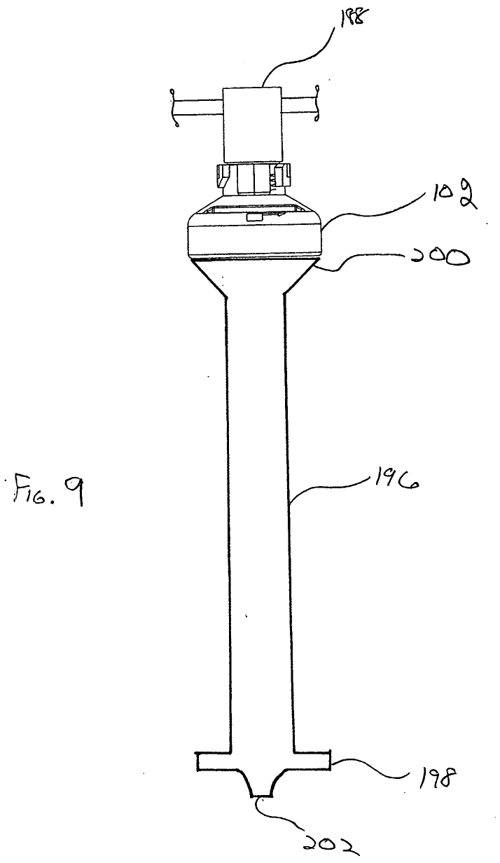

In use, the filter adapter system 102 is installed between a distribution manifold 188 and a cartridge filter 190, for example, as shown in FIG. 6. In the embodiment of the manifold in FIG. 6, manifold 188 comprises a manifold body 220, key-ways 222, 224 and a lock extension 226. Upon attachment of manifold 188 with adapter 102, keys 162 engage with keyways 222, 224. Lock extension 226 comprises projection 230, engagement element 232 and release knob 234. The engagement of locking tab 152a with engagement element 232 is shown in FIG. 7. Release knob 234 can be pulled by a user to disengage engagement from locking tab 152 such that adapter 102 can be removed from the manifold. An alternative embodiment of a manifold is shown in FIGS. 8a and 8b. In this embodiment, locking tab 152 engages with teeth 240 that provide for rotation in one direction while locking the adapter to the manifold by preventing rotation in the opposite direction. A person of ordinary skill in the art can design appropriate locking features for other engagement mechanisms for different filter and manifold designs based on the disclosure herein.

For purposes of a description of the filter adapter system 102, installation of the filter adapter system 102 is described in a two-step sequence. First, filter adapter 102 is sealingly attached to the distribution manifold 188. Distribution manifold 188 generally comprises an unfiltered water supply line 192 and a filtered water distribution line 194. In some embodiments, distribution manifold 188 also comprises keyed surface features as disclosed in U.S. Pat. No. 6,458,269 to Bassett et al. which is hereby incorporated by reference in its entirety. In practice, projecting section 132 is slidingly inserted into an aperture presented on the distribution manifold. As projection section 132 is inserted, key member 162 engages with a key-way on the distribution manifold 188. With key member 162 and the distribution manifold key feature engaged, the user can turn the filter adapter 102 relative to the distribution manifold 188 such that filtered water bore 174 aligns with a flow channel connected to filtered water distribution line 194 and the circumferential unfiltered water bore 184 aligns with a flow channel connected to unfiltered water supply line 192.

As described in the previously referenced patent to Bassett et al., distribution manifold 188 can comprise a wide variety of key combinations. As such, key member 162 of filter adapter 102 is capable of a wide variety of combination of tabs 164 and recesses 166 to facilitate sealing engagement of the filter adapter 102 and the distribution manifold 188. It is also envisioned that key member 162 may incorporate a “skeleton key” feature in which a single key member configuration could interface with a variety of different key combinations presented on a distribution manifold 188.

In addition to the features already described, it will be understood that a filter adapter 102 of the present invention may engage with an adapter insertion tool 196 as shown in FIG. 9, allowing for installation of filter adapter 102 to distribution manifold 188 in situations where distribution manifold 188 is located at a point that is difficult to access by hand. Adapter insertion tool 196 may comprise a biasing end 198 and an interface end 200. Biasing end 198 may have a grip-able member 202 allowing a user to grasp and turn the adapter insertion tool 196 during the process of attaching or removing the filter adapter 102 to distribution manifold 188.

Once filter adapter 102 is secured to distribution manifold 188, cartridge filter 190 is attached to projection section 170. Generally, cartridge filter 190 includes a filter cap including angled tabs or circumferential insertion ramps adapted to interface with recess tabs 142a, 142b and perimeter ramps 144a, 144b. Projection section 170 is typically slidingly inserted into a filter cap bore and cartridge filter 190 is rotated such that the angled tabs or circumferential insertion ramps interface with recess tabs 142a, 142b and perimeter ramps 144a, 144b to sealingly insert projection section 170 within the cartridge filter 190. As cartridge filter 190 attached to filter adapter system 102, an internal ramp surface on the filter cap contacts and biases valve member 108 to an open disposition such the unfiltered water can be supplied to the cartridge filter. Upon complete installation of the cartridge filter 190 to filter adapter 102, a continuous flow path is defined between unfiltered water supply line 192 and filtered water distribution line 194. Additional information concerning the installation of cartridge filter 190 to filter adapter 102 is disclosed in U.S. patent application Ser. Nos. 09/618,686, 10/196,340, 10/202,290 and 10/406,637, which are hereby incorporated by reference in their entirety.

Filter adapter 102 is specifically designed to remain coupled to distribution manifold 188 as cartridge filter 190 is either installed to or removed from filter adapter 102. This lockable mounting of filter adapter 102 to distribution manifold 188 can be accomplished in a variety of ways. One method is to dimension projection section 132, first manifold seal 114 and second manifold seal 116 such that a very tight interference fit is created between the filter adapter 102 and the distribution manifold 188 such that the torque necessary to attach and remove cartridge filter 190 to filter adapter 102 is significantly less than that necessary to remove the filter adapter 102 from the distribution manifold 188. Another method to accomplish secure attachment of filter adapter 102 to distribution manifold 188 is through the use of locking means such as locking tabs 152a, 152b, an angled locking means, a dimpled locking means for any other suitable connecting means, such that filter adapter 102 is frictionally engaged to the distribution manifold 188 and has a removal torque significantly higher than that required to simply disengage the cartridge filter 190 from the filter adapter 102. These types of locks are distinct locks involving interactions at adjacent surfaces of the adapter and the manifold away form the interlocking of the flow channels between the adapter and the manifold. Furthermore, in addition or as an alternative to the distinct locks, the locking adapter can comprise an interface lock incorporating mated interfaces between the adapter and the manifold that connect the flow channels. Specifically, the adapter-manifold interface lock can comprise locking threads, interference diameters, crushed ribs and/or polymers selected for blocking attachment to physically lock the elements at the adapter-manifold interface.

The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention.

1. A filter adapter comprising a manifold coupler, a filter coupler, a lock, a supply channel fluidly connecting the manifold coupler and the filter coupler, and a filter outlet channel fluidly connecting the manifold coupler and the filter coupler, wherein the filter outlet channel is isolated from the supply channel and wherein the manifold coupler is adapted to engage a manifold and the filter coupler is adapted for engaging a filter cartridge, the lock structure being positioned on the adapter to engage the manifold when the manifold coupler is engaged with the manifold with the lock resisting the disengagement of the filter adapter from the manifold.

2. The filter adapter of claim 1 wherein the manifold coupler comprises a body section and a manifold insertion section projecting from the body section, the manifold insertion section comprising a supply port connecting to the supply channel and a filtered outlet port connected to the filter outlet channel.

3. The filter adapter of claim 2 further comprising a first manifold seal and a second manifold seal, both of which are operably connected with the manifold insertion section, wherein the first manifold seal and the second manifold seal isolates flow into the supply channel and flow from the filter outlet channel when the manifold insertion section is engaged with the manifold.

4. The filter adapter of claim 2 wherein the lock comprises one or more locking tabs formed into an outside surface of the body section, wherein the locking tabs can engage corresponding structure on the manifold to secure the filter adapter to the manifold.

5. The filter adapter of claim 2 wherein the body section has a recess with a filter coupler.

6. The filter adapter of claim 1 wherein the filter coupler comprises a filter insertion section projecting outwardly, wherein the filter insertion section comprises a filtered water port connected to the filter outlet channel.

7. The filter adapter of claim 6 further comprising a supply surface, a first filter seal, a second filter seal, wherein the first filter seal surrounds the supply surface, and wherein the second filter seal engages the filter insertion section, and wherein the first and second filter seals isolates flow into the supply channel and flow from the filter outlet channel when the filter insertion section is engaged with the filter cartridge.

8. The filter adapter of claim 1 further comprising a valve assembly interposed in the supply channel, wherein the valve assembly comprises a valve body and a valve spring, and wherein the valve assembly regulates the flow of fluid through the supply channel and the valve body is displaced to an open configuration when a filter is engaged on the filter coupler.

9. The filter adapter of claim 1 wherein the manifold coupler further comprises a key member adapted to mate with and engage a corresponding key-way on a distribution manifold.

10. The filter adapter of claim 9 wherein the key member comprises a plurality of tabs and recesses.

11. The filter adapter of claim 1 wherein filter outlet channel comprises a central bore extending through the center of the filter adapter.

12. The filter adapter of claim 11 wherein the supply channel comprises a flow channel located radially outward from the filter outlet channel.

13. The filter adapter of claim 1 wherein the lock comprises a distinct lock with a locking element along a surface of the adapter that interfaces with a corresponding element of the manifold along a surface of the manifold.

14. The filter adapter of claim 1 wherein the lock comprises an interface lock.

15. A method of adapting a filter manifold comprising a filter-to-manifold coupler, the method comprising attaching a locking adapter to the filter-to-manifold coupler wherein the locking adapter comprises a filter-to-adapter coupler having a different configuration than the filter-to-manifold coupler and wherein the locking adapter comprises a lock that resists removal of the adapter from the manifold.

16. The method of claim 15 further comprising attaching a filter cartridge to the filter-to-adapter coupler of the locking adapter, wherein the filter cartridge has a filter-to-adapter coupler designed to interface with the filter to-to-adapter coupler of the locking adapter.

17. The method of claim 16 wherein the locking adapter further comprises a locking element that is adapted to engage with corresponding element on the filter manifold to lock the locking adapter to the filter manifold.

18. The method of claim 17 further comprising engaging the locking element with the corresponding locking element to lock the locking adapter to the filter manifold.

19. The method of claim 18 wherein the engaging step comprises rotating the locking adapter to engage to the locking element with the corresponding locking element.

20. The method of claim 15 wherein the locking adapter can engage a locking adapter tool to facilitate attaching the lock adapter to the filter-to-manifold coupler, the method further comprising engaging the locking adapter with the locking adapter tool.

21. A filtration assembly comprising:
a manifold having an inlet connection, an outlet connection, a filter-to-manifold coupler and a lock engaging member;
a filter comprising a case, a filter medium sealed within the case and a manifold-to-filter coupler having an inlet port and an outlet port; and
an adapter comprising a lock element, an manifold-to-adapter coupler mated to the filter-to-manifold coupler of the manifold, a filter-to-adapter coupler mated to the manifold-to-filter coupler of the filter to provide separate isolated passages with a supply passage between the manifold and the filter inlet port and a filtered flow passage between the manifold and the filter outlet port, wherein the lock element engages the lock engaging member.

22. An appliance comprising a water supply connection, a fluid dispenser and a filtration assembly of claim 21.

23. The appliance of claim 22 wherein the appliance comprises a refrigerator.

24. The filter assembly of claim 21 wherein the filtered flow passage comprises a central bore extending through the center of the adapter.

25. The filter assembly of claim 24 wherein the supply passage comprises a flow channel located radially outward from the filtered flow passage.

26. The filter assembly of claim 24 wherein the lock element comprises one or more locking tabs formed into an outside surface of the adpater.

27. A filter adapter comprising a manifold coupler, a filter coupler, a first channel fluidly connecting the manifold coupler and the filter coupler, and a second channel fluidly connecting the manifold coupler and the filter coupler, wherein the first channel is isolated from the second channel and wherein the manifold coupler is adapted to engage a manifold and the filter coupler is adapted for engaging a filter cartridge, the first channel comprising a central channel extending through the manifold coupler and the filter coupler and the second channel being radially outward from the central channel.

28. The filter adapter of claim 27 wherein the second channel comprises a valve assembly.

29. The filter adapter of claim 27 further comprising a lock positioned to engage the manifold when the manifold coupler is engaged with the manifold with the lock resisting the disengagement of the filter adapter from the manifold.
